(19) United States
(12) Patent Application Publication
(10) Pub. No.: US 2004/0111929 A1
(43) Pub. Date: Jun. 17, 2004

(54) Mousepad calendar

(76) Inventors: Susan Hickey, Greene, NY (US); Jacki Walters, Wilmington, OH (US); Kelli Widdifield, Dayton, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/611,391

(22) Filed: Jul. 1, 2003

Related U.S. Application Data
(60) Provisional application No. 60/393,274, filed on Jul. 1, 2002.

(51) Int. Cl. G09D 3/04; G09D 3/00

(52) U.S. Cl. 40/121; 40/107

(57) ABSTRACT

A mousepad calendar including a plurality of stacked sheets, each sheet having a calendar portion printed thereon. Each sheet is joined to any adjacent sheets at least partially along at least two separate edges of that sheet such that each sheet can be removed from the stack of sheets in a tear-off manner.

This application claims priority to Provisional Application Serial No. 60/393,274, filed Jul. 1, 2002, the contents of which are hereby incorporated by reference.

The present invention is directed to a calendar, and more particularly, to a mousepad calendar.

### BACKGROUND

Mousepads are widely used to provide a generally uniform, flat and preferably slightly frictional surface upon which a computer mouse or cursor control device may be rested or rolled as an operator uses a computer. As the user moves the mouse across the mousepad, the mouse ball rolls across the mousepad and such rolling movement can be detected by the mouse and/or computer and translated into movement of a cursor on a computer display device, such as a monitor. Alternately, movement of an optical mouse across a mousepad can be detected by optical equipment inside the mouse and/or computer.

### SUMMARY

In one embodiment, the present invention is a mousepad which provides a surface for supporting a mouse thereon, wherein the mousepad includes a calendar which can be used to provide quick and convenient indication of dates for planning purposes and the like. In another embodiment, the mousepad need not necessarily include calendar portions printed thereon, but can include other indicia or printed designs.

In one embodiment, the invention is a mousepad calendar including a plurality of stacked sheets, each sheet having a calendar portion printed thereon. Each sheet is joined to any adjacent sheets at least partially along at least two separate edges of that sheet such that each sheet can be removed from the stack of sheets in a tear-off manner. Other objects and advantages of the present invention will be apparent from the accompanying drawings and descriptions.

### BRIEF DESCRIPTION OF THE DRAWINGS

FIG. 1 is a front perspective view of one embodiment of the mousepad calendar of the present invention;

FIG. 2 is a front perspective view of the mousepad calendar of FIG. 1, with the top sheet thereof partially removed; and

FIG. 3 is a front perspective view of the mousepad calendar of FIG. 1, illustrating adhesive located at the corners thereof.

### DETAILED DESCRIPTION

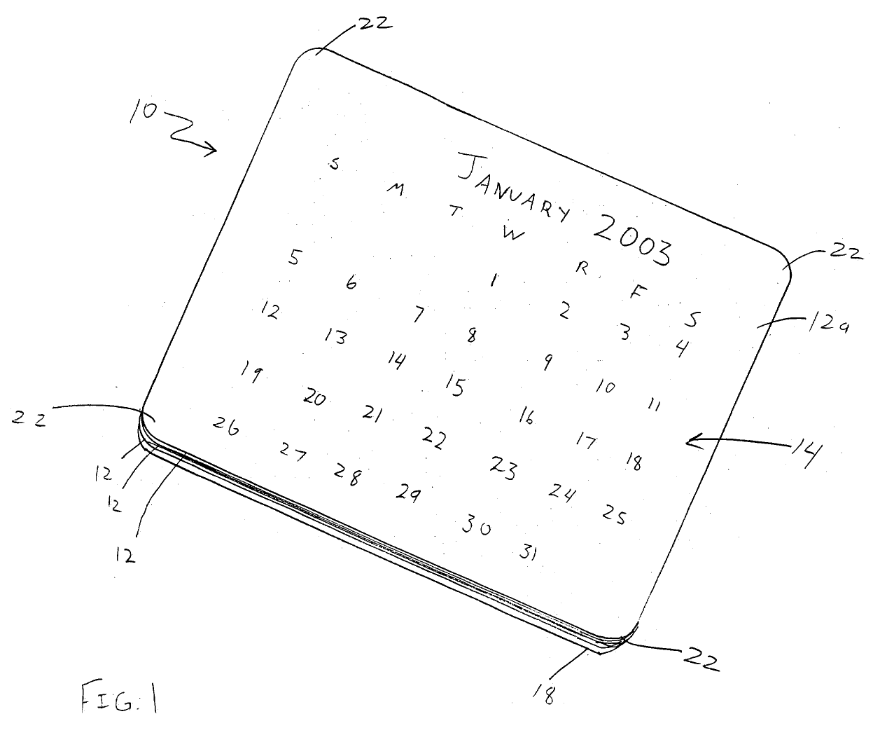

As shown in FIG. 1, the mousepad calendar of the present invention, generally designated 10, may include a plurality of stacked sheets 12, with each sheet 12 having a calendar portion 14 printed thereon. For example, the illustrated top sheet 12a includes a calendar for the month “January 2003” printed thereon. However, besides monthly calendars, the calendar portion 14 printed on each sheet 12 can be a calendar portion for any desired time frame, for example, weekly, daily, yearly, etc.

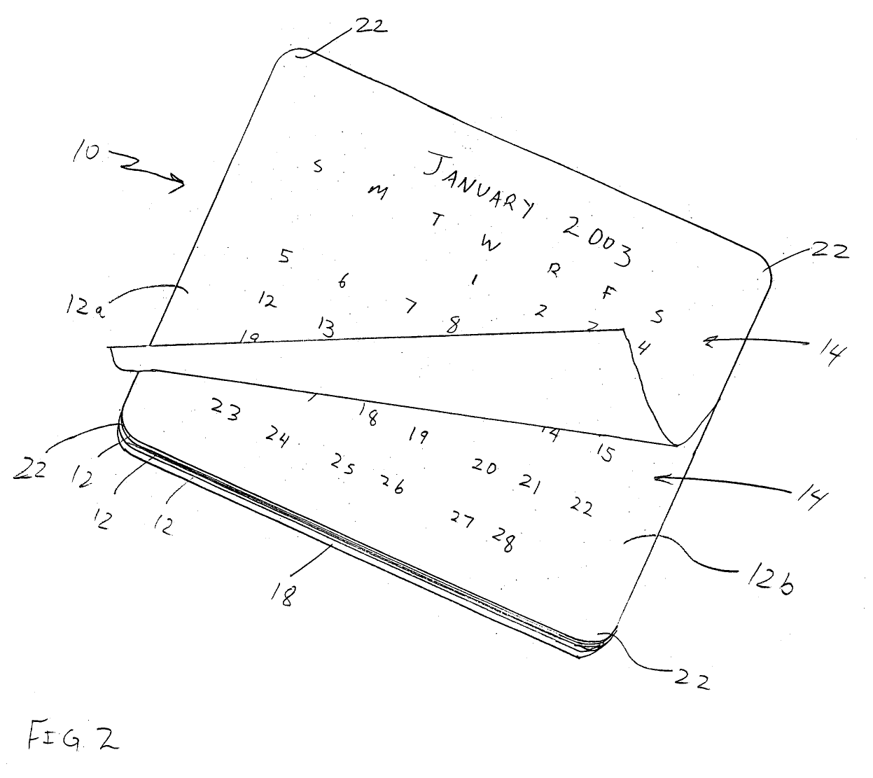

The sheets 12 are preferably interfacially arranged and stacked in a sequential or chronological manner, and the mousepad calendar 10 can include as many stacked sheets 12 as desired. For example, as shown in FIG. 2, a sheet 12b including the calendar portion “February 2003” may be located below the top sheet 12a. Thus, in one embodiment, each of the sheets 12 includes a monthly calendar portion printed thereon, and the mousepad calendar 10 includes about twelve to fourteen sheets 12 such that the mousepad calendar 10 can be used for an entire calendar year.

The mousepad calendar 10 may include a lower backing portion 18 which is preferably about the same shape and size as each of the sheets 12, but may be thicker and/or stiffer than the sheets 12 and may be made of, for example, cardboard. The backing portion 18 may be coupled to the lower-most sheet 12 and may include a nonskid portion located on a lower surface thereof.

Each of the sheets 12 may be generally rectangular in top view, and may include rounded corners 22 to prevent a mouse or other loose papers or articles from catching on the corners of the mousepad calendar 10. Each of the sheets 12 may be made of paper, plastic, composites, or nearly any sheet-like material upon which indicia can be printed. Furthermore, each of the sheets 12 may include an anti-static coating located on an upper surface thereof. Alternately, instead of having an anti-static coating, each of the sheets 12 may have additives or materials included therein that reduce the propensity of the sheets to accumulate a static charge, such as by decreasing the resistance of the sheets. Alternately, each of the sheets 12 may be made partially or entirely of an anti-static material. For example, each sheet may have a surface resistivity of between about 500 and about 5000 ohms meter, or between about 500 and 5000 megaohms meter.

In addition to or in place of including anti-static materials on or in each sheet, each of the sheets 12 may be treated to remove any or the majority of any static electricity in the sheets during manufacturing of the sheets 12. This process preferably occurs near or at the end of the manufacturing process of the sheets to ensure the sheets have or pick up a minimal amount of static electricity. The static electric charge of the sheets may be removed or reduced by a variety of methods, including but not limited to induction, ionization (including using ionized air blowers), compressed air static eliminators, pulsed DC static eliminators, anti-static bars, brushes, anti-static tinsel, passive static dischargers, by using a static neutralizer, or by other methods. Each sheet may be treated such that each sheet 12 has, carries or is capable of carrying a voltage of less than about 5000 volts, preferably less than about 1000 volts, preferably less than about 500 volts, further preferably less than about 100 volts, and further preferably less than about 10 volts.

When the sheets 12 have anti-static properties or a low static electricity charge and a mouse is located and rolled or moved across the upper surface of the uppermost sheet 12″, the anti-static or low-static nature of the sheet 12″ reduces dust accumulation and reduces interference with the electrical components of the mouse to help ensure proper functioning of the mouse. The reduced dust accumulation on the sheets 12 also reduces dust accumulation in the mouse.

Each of the sheets 12 may be attached to any adjacent sheets in a tear-off manner such that, for example, the uppermost sheet 12a can be removed and discarded when the appropriate time period has passed, thereby exposing the next sheet 12b which may include the appropriate subsequent calendar portion 14. In this manner, during a portion of the life of the mousepad calendar 10, each sheet 12 can provide a calendar portion 14 for viewing, while at the same time act as the upper surface and a mouse support.

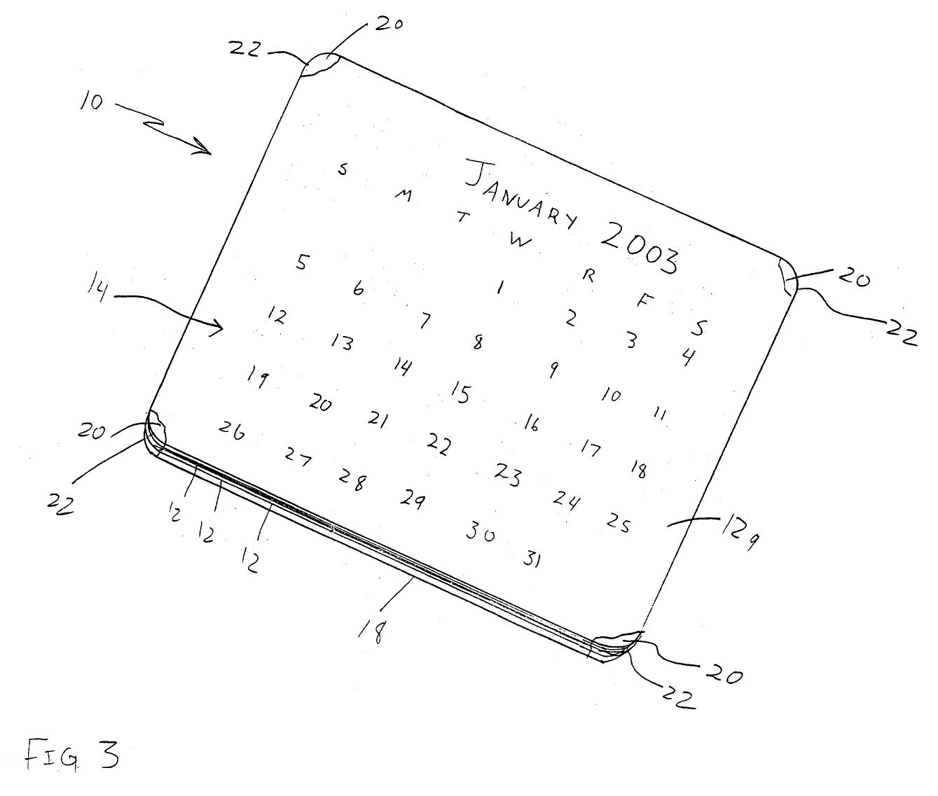

Each sheet 12 may be coupled to any adjacent sheets 12 at least partially along at least two edges 14 of each sheet 12 such that each of the sheets 12 (and in particular the uppermost sheet 12a) are secured and are restricted from flapping around or being accidentally torn off. In one embodiment, as shown in FIG. 3, the mousepad calendar 10 includes a relatively weak adhesive 20 deposited at each of the four corners 22 of the mousepad calendar 10 and contacting each corner 22 of each of the sheets 12 to secure each sheet 12 to any adjacent sheets. When the adhesive 20 is located on a corner 22, the adhesive 20 thus may extend at least partially along the two adjacent edges to aid in retaining the sheets 12 down.

The adhesive 20 may be a relatively weak adhesive, and may preferably be weaker than the strength of the materials of the sheets 12 themselves (i.e. the force required to tear one of the sheets 12). In this manner, when it is desired to remove a sheet (such as the uppermost sheet 12a), a user can slide his or her finger at an intermediate location between the attached corners 22 of the sheets and under the uppermost sheet 12a, and lift the uppermost sheet 12a upwardly to tear the adhesive 20 and break the uppermost sheet 12a away from the bulk of the mousepad calendar 10. In this manner, the uppermost sheet 12a can be removed to expose the next sheet 12b, thereby making that next sheet 12b the new uppermost sheet for use in supporting a mouse or other cursor control device.

The adhesive 20 enables the mousepad calendar 10 to be made without any binding mechanisms, such as a spiral binding mechanism, which can interfere with movement of a mouse upon the mousepad calendar 10. In particular, because the adhesive 20 conforms closely to the shape of the sheets 12, the adhesive does not extend outwardly a significant distance from the outer edges of the sheets 12 and thus does not present any structure that may interfere with the operation of a mouse on the mousepad calendar 10.

Although each of the sheets 12 is illustrated as being coupled to any adjacent sheet by an adhesive 20 at each of the corners 22 thereof, any of a wide variety of methods for coupling each sheet 12 to any adjacent sheet 12 may be used without departing from the scope of the present invention. For example, adhesives, mechanical fasteners, such as staples, clips, brackets and the like may be used for coupling the sheets 12.

The mousepad calendar 10 need not necessarily include a calendar portion 14 printed thereon. In particular, each sheet 12 may include a decorative feature such as designs, drawings, photographs, artwork or the like. Each of selected sheets 12 of the mousepad calendar 10 may also include inspirational quotes, factoids, formulas, equations or nearly any other designs or indicia. In this manner, the mousepad calendar 10 provides a top surface which can be modified or changed by the user, when desired, simply by tearing off the top sheet of the mousepad calendar 10.

The mousepad calendar 10 can have nearly any desired shape or size. However, as noted above, in one embodiment the mousepad calendar 10 is generally rectangular, and may be sized to provide a surface large enough to accommodate a typical desired range of motion of a computer mouse, but not so large so as to take up a large amount of space on a desktop. For example, in one embodiment the mousepad calendar 10 has a length of between about 5″-12″ (preferably about 8¾″) and a height of between about 4″ and 9″ (preferably about 6½″)

Having described the invention in detail and by reference to the preferred embodiments, it will be apparent that modifications and variations thereof are possible without departing from the scope of the invention.

What is claimed is:

1. A mousepad calendar comprising a plurality of stacked, chronologically arranged sheets, each sheet having a calendar portion printed thereon, each sheet being joined to any adjacent sheets at least partially along at least two separate edges of that sheet such that each sheet can be removed from said stack of sheets in a tear-off manner.

2. The mousepad calendar of claim 1 wherein each sheet has an anti-static electric property or a reduced static electricity charge such that each sheet carries a static electricity charge of less than about 100 volts.

3. The mousepad calendar of claim 1 wherein each sheet is generally rectangular in top view and is joined to each adjacent sheet at each corner thereof.

4. The mousepad calendar of claim 1 wherein each sheet is generally rectangular in top view and each corner of each sheet is a generally rounded corner.

5. The mousepad calendar of claim 1 wherein each sheet has a different calendar portion thereon.

6. The mousepad calendar of claim 1 wherein each sheet is joined to said at least one adjacent sheet by a relatively weak adhesive such that each sheet can be separated from said at least one adjacent sheet by manually tearing said adhesive.

7. The mousepad calendar of claim 6 wherein said adhesive is weaker than said sheets.

8. The mousepad calender of claim 1 wherein each sheet is joined to said at least one adjacent sheet by a binding means which generally closely conforms to the shape of each sheet and does not protrude significantly outwardly from each sheet.

9. The mousepad calender of claim 1 wherein each sheet has a surface resistivity of between about 800 and about 3000 ohms.

10. The mousepad calender of claim 1 wherein each sheet of said plurality of sheet are generally aligned.

11. The mousepad calender of claim 1 wherein said plurality of sheets includes a first sheet with a first calender portion printed thoron, and a second sheet with a second calender portion printed thereon.

12. The mousepad calender of claim 1 wherein said calender portion is a calender portion for less than a calender year.

13. The mousepad calender of claim 1 wherein said calender portion is a month.

14. The mousepad calendar of claim 1 further comprising a backing pad coupled to a bottom one of said sheets, said backing pad having a stiffness greater than each of said sheets and having about the same shape and size in top view as said bottom one of said sheets.

15. A mousepad calendar comprising a plurality of stacked sheets, each sheet having a calendar portion printed thereon and being joined to at least one adjacent sheet, each sheet having an anti-static electric property or a reduced static electricity charge.

16. The mousepad calendar of claim 15 wherein said anti-static electric property or said reduced static electric charge includes an anti-static coating on at least an upper surface of each sheet.

17. The mousepad calendar of claim 15 wherein said anti-static electric property or said reduced static electric property includes each sheet carrying a static electricity charge of less than about 100 volts.

18. The mousepad calendar of claim 15 wherein each sheet is joined to each adjacent sheet.

19. The mousepad calendar of claim 15 wherein each sheet is generally rectangular in top view and is joined to at least one adjacent sheet along at least two outer edges of said sheet.

20. The mousepad calendar of claim 15 wherein each sheet is generally rectangular in top view and is joined to each adjacent sheet at each corner thereof.

21. The mousepad calendar of claim 15 further comprising a backing pad coupled to a bottom one of said sheets, said backing pad having a stiffness greater than each of said sheets and having about the same shape and size in top view as said bottom one of said sheets.

22. The mousepad calendar of claim 15 wherein each sheet is generally rectangular in top view and each corner of each sheet is a generally rounded corner.

23. The mousepad calendar of claim 15 wherein each sheet has a different calendar portion thereon, and wherein said plurality of sheets are stacked in chronological order.

24. The mousepad calendar of claim 15 wherein each sheet is joined to said at least one adjacent sheet by a relatively weak adhesive such that each sheet can be separated from said at least one adjacent sheet by manually tearing said adhesive.

25. The mousepad calendar of claim 24 wherein said adhesive is weaker than said sheets.

26. The mousepad calendar of claim 15 wherein each sheet is joined to an adjacent sheet in a tear-off manner.

27. The mousepad calendar of claim 15 wherein each sheet has a surface resistivity of between about 800 and about 3000 ohms.

28. A method for using mousepad calendar comprising the steps of:
providing a mousepad calendar including a plurality of stacked sheets, each sheet having a calendar portion printed thereon and being arranged in chronological order and joined to at least one adjacent sheet, each sheet being joined to the associated at least one adjacent sheet at least partially along at least two separate edges thereof;
locating a computer mouse on top of said mousepad calendar; and
moving said computer mouse along said mousepad calendar to cause corresponding movement of a cursor on a computer display device.

29. The method of claim 28 further comprising the step of removing an upper one of said sheets to expose another of said sheets.

30. A method for manufacturing a mousepad calendar comprising the steps of:
providing a plurality of sheets, each sheet having a calendar portion printed thereon and having an anti-static electric property or a reduced static electric charge;
stacking said plurality of sheets on top of one another; and
joining each sheet to at least one adjacent sheet.

31. The method of claim 30 wherein said anti-static electric property or said reduced static electric charge includes each sheet carrying a static electricity charge of less than about 100 volts, wherein each sheet is joined to each adjacent sheet by an adhesive, and wherein each sheet is joined to each adjacent sheet at least partially along at least two edges thereof.
